(19) United States
(12) Patent Application Publication
(10) Pub. No.: US 2005/0024328 A1
(43) Pub. Date: Feb. 3, 2005

(54) Control area selection in a computing device with a graphical user interface

(76) Inventor: Graham Oldfield, London (GB)

Correspondence Address: Richard C. Woodbridge, Esq.;Synnestvedt Lechner & Woodbridge, LLP, P.O. Box 592, Princeton, NJ, 08542-0592, US

(21) Appl. No.: 10/625,579

(22) Filed: Jul. 23, 2003

(51) Int. Cl. G09G 5/08

(52) U.S. Cl. 345/157

(57) ABSTRACT

The control areas (e.g. keys and buttons) in a GUI of a touch screen based computing device represented in a color mask stored on the device; the color mask has regions exactly corresponding in shape and size to each of the control keys or buttons; each region is completely filled with a unique color. In use, when a X,Y co-ordinate pair for a particular contact/touch point is generated, it is straightforward and very fast to extract the pixel color that is present at the same X,Y co-ordinates of the color mask. It is also then very fast and straightforward to establish the control area associated with that color by matching the pixel color to a table that stores each control area together with its associated color in the color mask.

### BACKGROUND OF THE INVENTION

1. Field of the Invention

This invention relates to a method of control area selection in a computing device with a graphical user interface, particularly a device with a touch screen.

2. Description of the Prior Art

A common problem in Symbian OS and other GUI (graphical user interface) based operating systems for computing devices is determining what control area in a GUI has actually been selected by a user, e.g. what particular control key or button is meant to be selected when a user taps a touch sensitive display screen. When a stylus taps the display screen, the touch position is translated into an X and Y co-ordinate. Touch screens typically comprise an Indium Tin Oxide (ITO) layer overlying a display (such as a LCD) and are pressure sensitive. When pressure is applied to the ITO overlay, the top flexible surface is locally deformed so that it makes contact with a stiff/solid base layer. An analogue voltage level across the ITO coating on the inside surface layer is interpreted by the device to give X, Y coordinates for the pressure point. Such devices are well-known and their manufacture has been detailed in for instance, U.S. Pat. No. 6,163,313 to Aroyan, et al. entitled “Touch sensitive screen and method”, the contents of which are hereby incorporated by reference.

The X, Y co-ordinate is then delivered by the OS to the current window that fell under the co-ordinate. The window will have a number of control areas and each will typically have to be interrogated to find out which one falls under the co-ordinates. Such systems may be implemented as discussed in detail in for instance, U.S. Pat. No. 5,177,328 to Ito, et al. entitled “Information processing apparatus” or in U.S. Pat. No. 5,757,361 to Hirshik entitled “Method and apparatus in computer systems to selectively map tablet input devices using a virtual boundary”, the contents of both of which are hereby incorporated by reference.

FIG. 1 shows a User Interface (UI) control 10 designed to allow user input. The control in FIG. 1 defines seven control areas that the user can select; these are “Up” selection area 12, “Down” selection area 14, “Left” selection area 16, “Right” selection area 18, “Confirm” selection area 20, “Yes” selection area 22 and “No” selection area 24.

To represent these control areas in the Operating System (OS), each is defined very approximately as a rectangle. For example the ‘Up’ control may be recorded as a rectangle 19 with its top left co-ordinate pair 26 as X 68, Y 4 and its bottom left co-ordinate pair 28 as X 111, Y 29, as shown in FIG. 2. FIG. 2 shows all seven rectangles 19, 21, 23, 25, 27, 29 and 31 corresponding to the seven different control areas 12, 24, 18, 14, 16, 22 and 20.

Given that each of the seven selectable control areas is loosely defined as a rectangle, the UI can now determine which area was selected by a pen/stylus. When the user touches the display screen overlying a given control area, X and Y co-ordinates where the pen touched are generated. The device then examines each rectangle to see if the X, Y co-ordinates fall within the bounds of that rectangle. A typical algorithm to determine if a X Y co-ordinate pair falls within the bounds of a rectangle is:

1. Is the User selected X co-ordinate greater than a control area's top left X co-ordinate.

2. Is the User selected X co-ordinate less than a control area's bottom right X co-ordinate.

3. Is the User selected Y co-ordinate greater than a control area's top left Y co-ordinate.

4. Is the User selected Y co-ordinate less than a control area's bottom right Y co-ordinate.

If all the above conditions are true then the UI determines that the user has selected that control area.

This algorithm must be run across every rectangle to discover which control area the user has selected. Given the complexity of many control designs and the consequent large number of rectangles, this can be a relatively time consuming processes.

Another disadvantage is that the only portions of control areas that can be captured are rectangles; this means graphically intensive control designs, such as control buttons with complex shapes, can be hard to capture pointer events from accurately. FIG. 3 shows a region where the user selected the ‘down’ control area 14; however in this example this event would be missed as area of contact 13, while in the control area 14, is outside the bounds of the ‘down’ rectangle 25.

Whilst its possible to capture user input with rectangles, there are therefore 3 main drawbacks:

Hit areas have to be rectangular. Arbitrary shaped controls cannot be selected accurately.

An algorithm examining 2 pairs of co-ordinates must be run across every hit area.

It is time consuming to change the design of the control as all of the co-ordinate pairs that describe the hit rectangles must be recalculated.

### SUMMARY OF THE INVENTION

In a first aspect, a method of establishing which control area shown on a display of a computing device has been selected by a user, in which each of several different selectable control areas is associated with one of a set of unique colors in a color mask stored in device memory, the color mask being made up of regions that each correspond to one of the control areas and are each colored in one of the unique colors; comprises the steps of:
(a) generating a set of co-ordinates for a contact location on the display;
(b) retrieving the color mask color at that set of co-ordinates;
(c) establishing the control area which is associated with the same color as the retrieved color.

Hence, instead of making a loose rectangular approximation to a control key or button, the present invention requires a color mask with a region preferably exactly corresponding in shape and size to that control key or button to be created and stored in memory; the region is completely filled with a unique color. Any other control keys or buttons visible at the same time are given corresponding uniquely colored regions in the color mask. The device will hence store a set of different color masks, each corresponding to a different control key/button arrangement. Some color masks may be burned in device ROM (e.g. for GUI control designs that are meant always to be available); others may be part of application software loaded into the device by an end-user, where the color masks relate to GUI control designs specific to that application software.

In use, when a X,Y co-ordinate pair for a particular contact/touch point is generated, it is straightforward and very fast to extract the pixel color that is present at the same X,Y co-ordinates of the appropriate color mask. From there, it is also very fast and straightforward to establish the control area associated with that color. For example, imagine a control design in which an icon is displayed in the center of the screen. The icon is a complex shape, such as a flower. If the flower is selected, then an imaging application opens. There are no other control areas on the same screen. Then, a color mask in exactly the shape of the flower is created when designing the device or the imaging application; the internal parts of the flower are given a color, say blue, in the mask. The rest of the color mask if black. The color mask is stored in device memory. When the device is in use, the flower icon is displayed. The user touches any part of the flower: the touch co-ordinates are generated and then used to retrieve the color in the color mask at the same co-ordinates. If the color mask color is blue, then the device compares this to the possible color s (blue and black) using a table which also associates each color with a control area (e.g. blue+flower; black+no function). It can then rapidly determine that the flower has been selected. If the color mask color is black, then the device knows that the user has touched the screen outside of the flower icon.

The term ‘computing device’ covers any kind of computing device that a person interacts with by selecting control areas that are shown on a display. As such, the term covers Personal Digital Assistants (PDA)s, mobile telephones, dedicated devices such digital audio players, remote control units, etc. The term ‘control area’ should be expansively construed to cover any object which a user would ‘select’ in some way (e.g. choose in order to: (a) input data, such as text/numeric data; (b) initiate an action; (c) control or manipulate a function; or (d) to identify data which is to be manipulated). It therefore covers keys or tiles from a keyboard (such as letter or number keys), a control button or slider, a jog dial, a joystick, or a roller button etc. The term ‘control area’ also covers items that do not correspond with objects as such; in particular, it covers any icon or image which a user might select.

### BRIEF DESCRIPTION OF THE DRAWINGS

The present invention will be described with reference to the accompanying drawings, in which:

FIG. 1 shows the GUI control design appearing on part of a computing device screen; the control design has seven different control areas.

FIG. 2 shows the prior art rectangle based approach to establishing which of the seven control areas has been selected by a user;

FIG. 3 shows how the prior art does not cope well with complex control areas;

FIG. 4 shows a color mask as used in the present invention; there are seven different control regions, each the exact same shape and size as a corresponding control area in the GUI control design that appears on the display;

FIG. 5 shows how the device stores the original control design bitmap, the color mask and a table of colors linked to control areas;

FIG. 6 is a flow chart of the key steps in the present invention;

FIG. 7 shows a different GUI control design with the same kinds of control areas as the FIG. 1 GUI control design;

FIG. 9 shows how this different GUI control design can be simply implemented by using a different color mask.

### DETAILED DESCRIPTION OF THE INVENTION

During the course of this description like numbers will be used to identify like elements according to the different views which illustrate the invention.

In a preferred embodiment of the present invention, a color mask solution replaces the multiple rectangle hit area approach with a color mask stored in memory. The color mask is a direct representation of the control areas from which data input is captured, with each color region corresponding to a distinct control area. The mask may be created from the original control area bitmap by filling in color mask regions which will be used to capture user input, with the solid color corresponding to the control area.

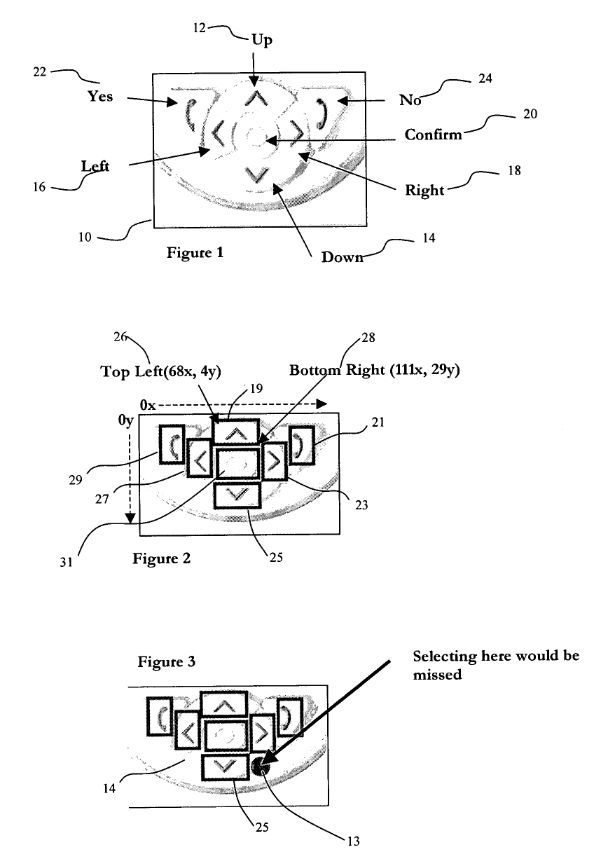

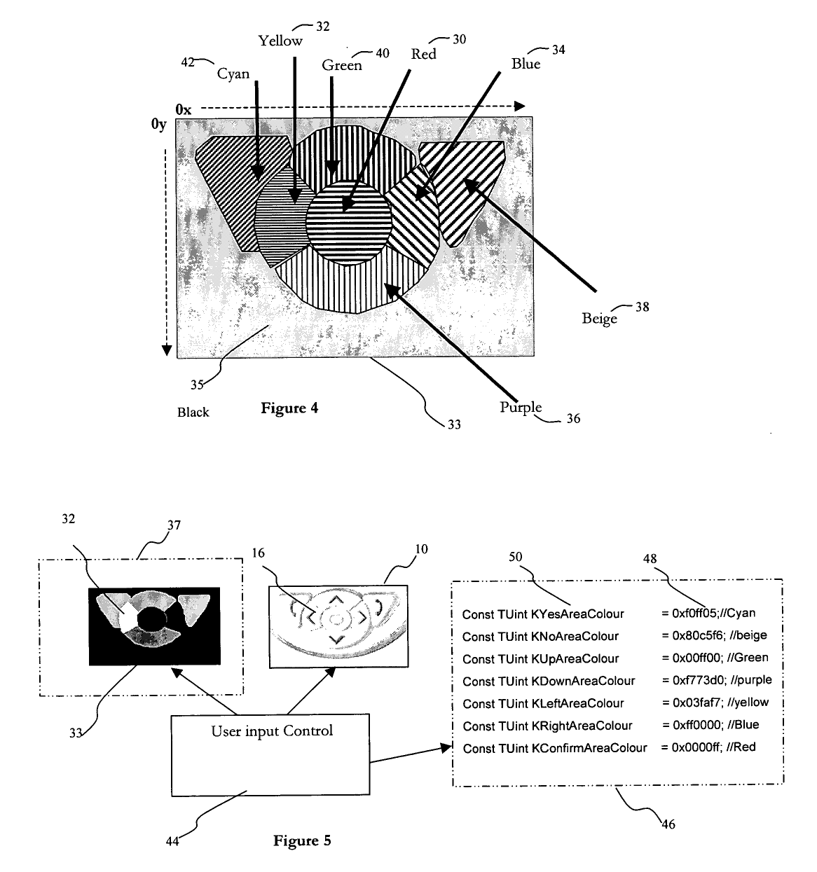

FIG. 4 shows a color mask 33 representing the User Interface (UI) control of FIG. 1. Any region 35 of the color mask not wanted to count as user input, is colored black. The color mask regions of interest that will be used to register user input may then be marked in appropriately different colors. For example FIG. 4 shows a red region 30 corresponding to the “Confirm” control area 20, a yellow region 32 corresponding to the “Left” control area 16, a blue region corresponding to the “Right” control area 18, a purple region 36 corresponding to the “Down” control area 14, a blue region 34 corresponding to the “No” control area 24, a cyan region 42 corresponding to the “Yes” control area 22, and a green region 40 corresponding to the “Up” control area 12.

In SymbianOS each color is stored as 32 bit unsigned integer with the format BB GG RR (Blue Green Red) so primary red would be 0x0000ff, green 0x00ff00 and blue would be 0xff0000.

A table of the known region colors may be stored in a device memory 46. The table may consist of member variables 48 associated with a reference to a corresponding control area 50 as shown in FIG. 5 and in Table 1 below.

TABLE 1

| | |
|---|---|
| Const TUint KYesAreaColor | = 0xf0ff05;//Cyan |
| Const TUint KNoAreaColor | = 0x80c5f6; //beige |
| Const TUint KUpAreaColor | = 0x00ff00; //Green |
| Const TUint KDownAreaColor | = 0xf773d0; //purple |
| Const TUint KLeftAreaColor | = 0x03faf7; //yellow |
| Const TUint KRightAreaColor | = 0xff0000; //Blue |
| Const TUint KConfirmAreaColor | = 0x0000ff; //Red |
| Const TUint KblackIgnoreArea | = 0x000000; //Black |

The color mask 33 is also stored in a device memory 37 as a member variable.

The color mask may for example be used as follows. If the user selects the ‘Left’ control area 16 by tapping on it with a stylus, an application or program 44 would receive notification of an event occurring with some co-ordinate location, which may for example be the coordinate pair x 58, y 41, defining the stylus contact position.

The program 44 establishing the control area which has been selected then asks for the value of the pixel in the color mask 33 at the event location, in this example the value of the pixel at the coordinate location x 58 y 41. In one embodiment of the invention utilizes the Symbian OS, in whic all bitmaps are represented in memory as collections of pixels, (pixels are typically unsigned integers that represent color in the same format as described earlier in Table 1 of known colors). Many operating systems such as, but not limited to, the Symbian OS and other GUI based Operating Systems, provide a quick method to retrieve a pixel from a bitmap in memory and this functionality may be used to efficiently retrieve a pixel value from a given event location, such as the value of the pixel at coordinate pair location x58 y41 in this example.

In this example, the value of the pixel at X58 y41 would be retrieved from the color mask as TUint 0x03faf7 (corresponding in this embodiment to the color yellow). The program may then use a statement such as the following code fragment:

Void UserSelectedControl(Tint XselectedCoordinate, Tint

YselectedCoordinate)
{
const TUint selectedPixel = MyOffScreenMask−>GetPixel (XselectedCoordinate,
YselectedCoordinate );
switch(selectedPixel)

{
case KblackIgnoreArea: //black

//No control area selected we can ignore event
break

case KyesAreaColor:

DoYesAction();
break;

case KNoAreaColor:

DoNoAction();
break;

case KUpAreaColor:

DoUpAction();
break;

case KdownAreaColor:

DoDownAction();
break;

case KleftAreaColor:

DoLeftAction();
break;

case KrightAreaColor:

DoRightAction();
break;

Default:

break;

};

}

In this example the pixel value 0x03faf7 would be matched to the KLeftAreaColor variable (0x03faf7) as shown in Table 1 and in FIG. 5 (i.e. the program 44 matches the pixel color yellow 32 to the control area associated with that color, namely the ‘left’ control area 16). Hence, the program 44 would determine that the user has selected ‘left’. The relevant part of the program statement is shown in bold in the code fragment above.

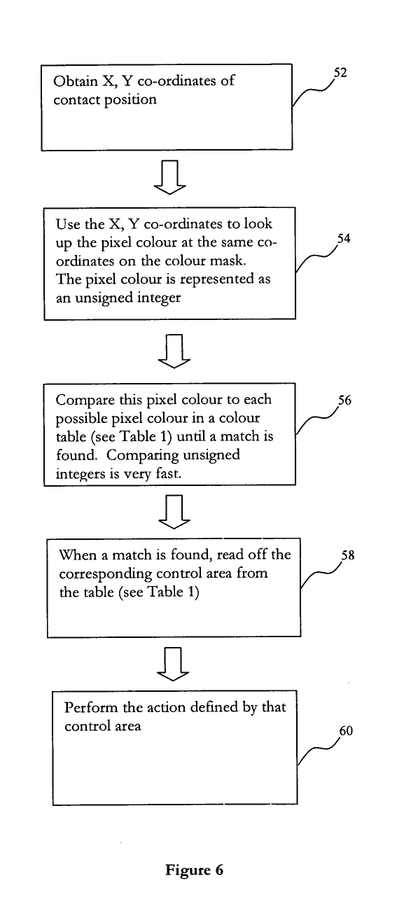

The key steps are summarised in FIG. 6.

In step 52, a position of a contact point on a Graphic User Interface (GUI) is obtained. The contact may for instance be where a stylus, a finger or other pointing mechanism has touched or come into the proximity of a suitably sensitised surface such as, but not limited to, a well-know ITO touch screen. The contact point may be represented in a suitable two-dimension coordinate system such as, but not limited to, the well-known Cartesian coordinate system having orthogonal x and y axis.

In step 54 the coordinates of the contact point are used to obtain the color value of the corresponding pixel in a color mask associated with the GUI. The color value may be encoded in any reasonable way such as, but not limited to, representing the color value as an unsigned integer.

In step 56 the color value of the pixel corresponding to the contact point is compared with the color values associated with control areas. This may for instance be done by interrogating or searching a lookup table in which control areas are associated with specific colors or ranges of color.

In step 58, if a color value match is found, that is the color of the contact point pixel matches a control area color value, or is within a control area's specified range of color values, that control area is associated with the contact.

In step 60 the operating system or application performs the function or action specified by the control area found in step 58. In this way the physical contact detected in step 52 is translated into a specific action by means of the color bit map and the predefined look up table that relates color to function.

So long as each region in the color mask has a unique value, any color (which term also includes grey scale) combination can be used.

The method of this invention is more efficient in terms of processing time than the prior art, especially when pixel value are stored as unsigned integers. In such an embodiment, step 56 of determining if the contact event is in an active region simply consists of comparing one unsigned integer against a single unsigned integers for each of the predefined different color regions (each of which has a 1:1 correspondence to a control area). If the control design is complex, examining all the different rectangles using a prior art approach is complex and time consuming. With the color mask approach only the different color areas need be compared with the event pixel color.

Customisation

Another advantage of the color mask approach is that the look and feel of the control design can be completely changed, by simply updating the mask and the original control bitmap.

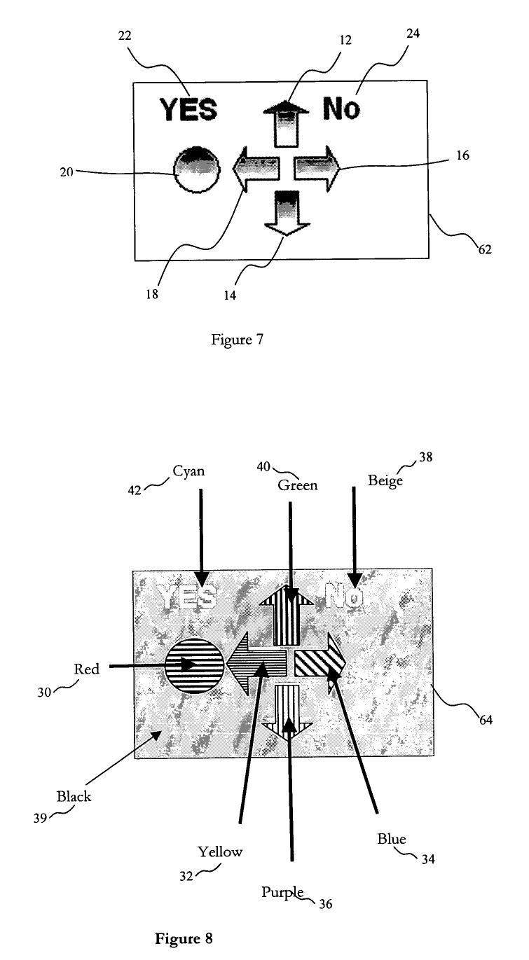

FIG. 7 shows a complete re-design of the original control (in FIG. 1). This new design 62 however still has exactly the same seven control areas as the original control design e.g. “Up” selection area 12, “Down” selection area 14, “Left” selection area 16, “Right” selection area 18, “Confirm” selection area 20, “Yes” selection area 22 and “No” selection area 24. This new design would be extremely difficult to represent with the rectangle approach as it contains many non-rectangular hit areas.

To update this control design 62 with the color mask approach simply requires creating a new color mask bitmap 64 that represent the new control design. The new color mask bitmap 64 is shown in FIG. 8 and could be created by somebody with little technical knowledge in for instance, but not limited to, many of the well-known paint graphic applications. The only criteria is that exactly the same color values are used to represent the same control areas, as previously defined in for instance, Table 1. For example the red region 30 still corresponds to the “Confirm” control area 20, the yellow region 32 still corresponds to the “Left” control area 16, the blue region still corresponds to the “Right” control area 18, the purple region 36 still corresponds to the “Down” control area 14, the blue region 34 still corresponds to the “No” control area 24, the cyan region 42 still corresponds to the “Yes” control area 22, and the green region 40 still corresponds to the “Up” control area 12.

With the new Control design 62 and color mask bitmap 64 added to the application no code changes are required. This is because the color mask approach only needs to know which colors represent which control action (e.g. as shown in Table 1).

While the invention has been described with reference to the preferred embodiment thereof, it will be appreciated by those of ordinary skill in the art that modifications may be made to the structure and elements of the invention without departing from the spirit and scope of the invention as a whole.

1. A method of establishing which control area shown on a display of a computing device has been selected by a user, in which each of several different selectable control areas is associated with one of a set of unique colors in a color mask stored in device memory, the color mask being made up of regions that each correspond to one of the control areas and are each colored in one of the unique colors;
comprising the steps of:
(a) generating a set of co-ordinates for a contact location on the display;
(b) retrieving the color mask color at that set of co-ordinates;
(c) establishing the control area which is associated with the same color as the retrieved color.

2. The method of claim 1 in which the color mask is obtained using a bit map of the control areas.

3. The method of claim 2 in which a table of the set of unique colors is stored in device memory, together with a reference to each associated selectable control area.

4 The method of claim 3 in which each of the unique colors in the table is represented as an unsigned integer.

5. The method of claim 4 in which each of the unique colors in the color mask is represented as an unsigned integer and the unsigned integer representing the color at the set of co-ordinates is compared against each unsigned integer in the table until a match is found.

6. The method of claim 5 in which, when a match is found, the corresponding selectable control area is then established using the table.

7. The method of claim 1 in which a selectable control area can be any arbitrary shape so long as the color mask region corresponding to that arbitrary shape can be filled with a single color.

8. The method of claim 2 in which the arrangement or design of the different selectable control areas is updatable to a different arrangement or design by altering the bit map of the control areas and the color mask.

9. The method of claim 8 in which altering the bit map of the control areas and the color mask is performed using a paint application.

10. A computing device adapted to establish which control area shown on a display of the computing device has been selected by a user, in which each of several different selectable control areas is associated with one of a set of unique colors in a color mask stored in device memory, the color mask being made up of regions that each correspond to one of the control areas and are each colored in one of the unique colors; the device being adapted to:
(a) generate a set of co-ordinates for a contact location on the display;
(b) retrieve the color mask color at that set of co-ordinates;
(c) establish the control area which is associated with the same color as the retrieved color.

11. The device of claim 10 in which the color mask is obtained using a bit map of the control areas.

12. The device of claim 11 in which a table of the set of unique colors is stored in device memory, together with a reference to each associated selectable control area.

13. The device of claim 12 in which each of the unique colors in the table is represented as an unsigned integer.

14. The device of claim 13 in which each of the unique colors in the color mask is represented as an unsigned integer and the unsigned integer representing the color at the set of co-ordinates is compared against each unsigned integer in the table until a match is found.

15. The device of claim 14 which, when a match is found, establishes the corresponding selectable control area using the table.

16. The device of claim 10 in which a selectable control area can be any arbitrary shape so long as the color mask region corresponding to that arbitrary shape can be filled with a single color.

17. Application software programmed to run on a computing device, in which the application software causes each of several different selectable control areas to be displayed on the device and comprises a color mask, the color mask being made up of regions that each correspond to one of the control areas and are each colored in a unique color.
